(19) United States
(12) Patent Application Publication
(10) Pub. No.: US 2006/0173874 A1
(43) Pub. Date: Aug. 3, 2006

(54) Method and system for interactive parameter optimization using multi-dimensional scaling

(76) Inventors: Yunqiang Chen, Plainsboro, NJ (US); Jason Jenn-Kwei Tyan, Princeton, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/342,150

(22) Filed: Jan. 27, 2006

Related U.S. Application Data
(60) Provisional application No. 60/649,714, filed on Feb. 3, 2005.

(51) Int. Cl. G06F 17/30

(52) U.S. Cl. 707/100

(57) ABSTRACT

A method for interactively optimizing a system comprises interactively adjusting controlling parameters in a parameter set, by deriving successive pluralities of parameter sets in a parameter space, each of whose respective member parameter sets are respectively ranked in order, utilizing a ranking input based on respective system performance associated with each parameter set and from each of which plurality of parameter sets an optimal parameter set is selected and used as a point of departure for deriving the next following plurality of parameter sets in the parameter space, in accordance with the preceding ranking, in conjunction with a step size and a step direction derived from the ranking, in accordance with multidimensional scaling (MDS).

### CROSS-REFERENCE TO RELATED APPLICATIONS AND CLAIM OF PRIORITY

Specific reference is hereby made to copending U.S. Provisional Patent Application No. 60/649,714 (Attorney Docket No. 2005P01970US) filed Feb. 3, 2005, in the names of the inventors in the present application, Andreas Streich, Yunqiang Chen, and Jason Jenn-Kwei Tyan, and entitled Interactive Parameter Optimization Using Multi-Dimensional Scaling, and whereof the disclosure is hereby incorporated herein by reference and whereof the benefit of priority is claimed.

### FIELD OF THE INVENTION

The present invention relates to the field of system optimization by interactive adjustment of system control parameters and, more particularly, to interactive parameter optimization using multi-dimensional scaling. The invention is broadly applicable to optimizing systems, an important field of application being image optimization.

### BACKGROUND OF THE INVENTION

Typically, imaging devices or image processing algorithms are controlled by some important parameters. Different image outputs suitable for different needs or personal preferences are obtainable by changing the parameters. It is herein recognized that obtaining a set of optimal parameters can be treated as an optimization problem. Usually, the optimization criteria, that is, objective functions such as, for example, image quality or personal preference, are very complex or generally cannot be explicitly evaluated. Their derivatives, required in a traditional optimization framework, may not exist at all in any practical sense.

### BRIEF SUMMARY OF THE INVENTION

The present invention focuses on the foregoing kind of derivative-free optimization problem and discloses an effective method that converges much faster than algorithms traditionally used in such applications.

In accordance with an aspect of the invention, a method for optimizing a system comprises interactively adjusting controlling parameters in a parameter set and deriving successive pluralities of parameter sets in a parameter space, each of whose respective member parameter sets are respectively ranked in order, utilizing a ranking input based on respective system performance associated with each parameter set and from each of which plurality of parameter sets an optimal parameter set is selected and used as a point of departure for deriving the next following plurality of parameter sets in the parameter space, in accordance with the preceding ranking, in conjunction with a step size and a step direction derived from the ranking, in accordance with multidimensional scaling (MDS).

While the present invention is broadly applicable to optimizing systems in general, its principles will also be explained herein, without loss of generality, by way of exemplary embodiments relating to an important field of application for the present invention, namely, to image optimization. An algorithm in accordance with the principles of the present invention will be explained and tested on fine-tuning parameters that control an image filtering algorithm. In the following exemplary embodiment, five parameters are used to control the filtering process, for example, noise reduction level, enhancement and so forth. The image quality is judged by the user, who applies judgment at a succession of iterations. At each iteration, a set of several images, 6 in the present exemplary embodiment, are generated by the filtering algorithm using different parameters. The user will proceed to rate all the images of the set, based on preference. Then the algorithm will generate a next set of filter parameters and corresponding filtering results, which will again be rated, starting the next iteration. The goal is to find the best parameter set to filter the image.

The user rating is mainly a relative one within the images of the current iteration. Comparison between the ratings of the images in different iteration steps is generally not appropriate.

It is herein recognized that the question of how to effectively search for the optimal parameters in the five-dimension parameter space without information of the exact target function or its derivatives poses a difficult, but general problem. An overview of the traditional optimization methods can be found in, for example, W. H. Press, B. P. Flannery, S. A. Teukolsky, and W. T. Vetterling: Numerical Recipes in C. Cambridge University Press, Cambridge, UK, 2nd. Edition, 1992; and in S. C. Chapra, R. P. Canale: Numerical Methods for Engineers: With Software and Programming Applications. McGraw-Hill Publishing Co., 2001. Implementations for several methods can be found as addition to the theory, in K. Miettinen, Numerical Methods for Unconstrained Minimisation: an integrated Computational Environment, Dissertation at the University of Helsinki, 1993.

It is further herein recognized that traditional methods typically fail to fully utilize the user's feedback and do not converge very fast. In accordance with an aspect of the present invention, the relatively abundant information in the relative weighting of all the images is utilized, instead of relying only on the best-rated image as is generally done in traditional methods. In accordance with principles of the present invention, a multi-dimensional scaling algorithm is designed to find the optimal search direction in the parameter space, which best preserves the relative ranking between the above-mentioned parameters. The new algorithm converges much faster than the traditional methods in experiments carried out, as will be described further below.

Some of the traditional optimization methods for derivative-free optimization and their shortcomings will next be described, followed by a detailed description of the optimization method in accordance with the invention. Comparisons with several known methods are discussed.

As was mentioned some existing methods can be used for the present type of problem to be solved. However, these existing methods exhibit shortcomings and do not work effectively for the user feedback based optimization. Three principal methods are discussed next and their implementation and comparison with the method of the present invention in related experiments will be presented.

A commonly used, very robust and basically rather straightforward method uses normal distribution. Starting in the middle of the interval of typical values, initial parameters are generated with a medium standard deviation. This controls the closeness of sampling. Thereafter, the rating is utilized to compute a weighted mean as a new mean and a new standard deviation. As the number of parameter sets is very limited, a series of minimal conditions for the standard deviation as well as a gradual decrement are used to control exploration and convergence. These conditions are mainly needed to support the convergence, as the sampling of the parameter space is rather sparse with the relatively small number of images. The fine-tuning of the respective factors takes time and critically influences the quality of the algorithm. Once the search for good steering values has been done, the results obtained with this method were quite good.

Another method, also known as the Nelder-Mead Method (Amoeba algorithm), is a variation of the simplex method: starting from an initial simplex, the optimal is circled in by a sequence of reflections, expansions, contractions and shrinkings. As the ranking is for individual parameters, a major drawback of this method is that it needs immediate feedback after every parameter set, which is not suitable when a user rates a series of images. In the setting with direct comparison to a reference image, good results could nevertheless be obtained. The results were often the second best ones, after the results based on MDS. For further explanations see, for example, the afore-mentioned paper by W. H. Press et al., Numerical Recipes in C, and papers by J. O. Kephart, R. Das and J. K. MacKie-Mason: “Two-Sided Learning in an Agent Economy for Information Bundles,” in Proceedings of the Workshop on Agent-Mediated Electronic Commerce, International Joint Conference on Artificial Intelligence (UCAI-99), Stockholm, Sweden, Jul. 31-Aug. 6, 1999; and K. Chen: Material to the course Advanced Computational Techniques at the National University of Singapore, 2002. Available at http://www.cz3.nus.edu.sg/˜chenk/cz5201/note6.htm.

In the Variational Method/Golden Section Search (Brent), optimization is done in a more analytical way, varying one parameter at a time, and trying to find optimal values for each of them independently. The parameter dimension with the biggest uncertainty is chosen, the others being kept invariant. In the given direction, a Golden Section Search is made: starting with two points, a third point is selected that subdivides the interval in accordance with the golden section. If the middle point does not have the best rating, the interval is increased, until the middle point yields the best result. Then, the larger interval is again subdivided in accordance with the golden section and the corresponding point is rated.

In the case shown in the graph of FIG. 2, a and b are the initial points, and c is chosen such that
(c−a):(b−c)=φ
where φ denotes the golden section:

$$φ = \frac{\sqrt{5} - 1}{2} \approx 0.618034 .$$

As c gets the highest function value, this interval fulfills the requirement that the middle value is the best one. Then, the larger interval is divided again; d is chosen such that (d−c):(b−d)=φ. As the function value for d is higher than the function value for b, the points for the next step are a, c and d, and the interval [a, c] will be divided next.

This procedure is made circularly for every parameter until no significant increment in the rating is found.

The algorithm was found to converge slowly but steadily. It also has the drawback that the algorithm works with immediate feedback and can only be applied when comparing to a reference image. For the golden section step see, for example, G. Gonnet: Material to the course Scientific Computation at the Federal Institute of Technology, 2002, available at http://linneus20.ethz.ch:8080/1_{—}5.html. An application of the variational search 25 method can be found, for example, at Yixin Chen, Benjamin W. Wah: Calculus of Variations in Discrete Space for Constrained Nonlinear Dynamic Optimization. ICTAI 2002: 67-74.

In accordance with an aspect of the invention, a method for interactively optimizing parameters in a parameter set, comprises: deriving successive pluralities of parameter sets in a parameter space, each of whose respective member parameter sets are respectively ranked in order based on a ranking input, and from each of which an optimal parameter set is selected and used as a point of departure for deriving in a next iteration, the next following plurality of parameter sets in the parameter space, in accordance with the ranking input in the preceding iteration, in conjunction with a step size and a step direction derived from the ranking input, in accordance with multidimensional scaling (MDS).

In accordance with another aspect of the invention, method for interactively optimizing a system comprises: interactively adjusting controlling parameters in a parameter set, by deriving successive pluralities of parameter sets in a parameter space, each of whose respective member parameter sets are respectively ranked in order, utilizing a ranking input based on respective system performance associated with each parameter set and from each of which plurality of parameter sets an optimal parameter set is selected and used as a point of departure for deriving the next following plurality of parameter sets in the parameter space, in accordance with the preceding ranking, in conjunction with a step size and a step direction derived from the ranking, in accordance with multidimensional scaling (MDS).

In accordance with another aspect of the invention, a method for optimizing a system, comprises: interactively adjusting controlling parameters in a parameter set comprising respective member parameter sets, the adjustment comprising: deriving successive pluralities of parameter sets in a parameter space;. ranking each of the respective member parameter sets in order, utilizing a ranking input based on respective system performance associated with each parameter set; selecting an optimal parameter set from the plurality of parameter sets: and using the optimal parameter set as a point of departure for deriving a next following plurality of parameter sets in the parameter space, in accordance with the preceding ranking, in conjunction with a step size and a step direction derived from the ranking, in accordance with multidimensional scaling (MDS).

In accordance with another aspect of the invention, a method for optimizing a system, comprises: interactively adjusting controlling parameters in a parameter set comprising respective member parameter sets, the adjusting comprising: deriving a first plurality of parameter sets in a parameter space from a given parameter set for controlling the system; ranking each of the respective parameter sets in order, utilizing a ranking input based on respective system performance associated with each parameter set, wherein a topmost ranked parameter set is selected as a first optimal parameter set; and using the optimal parameter set as a point of departure for deriving a next following plurality of parameter sets in the parameter space, in accordance with the preceding ranking, in conjunction with a step size and a step direction derived from the ranking, in accordance with multidimensional scaling (MDS).

In accordance with another aspect of the invention, a method for interactively optimizing parameters in a parameter set for controlling an image filtering algorithm, comprises deriving successive pluralities of parameter sets in a parameter space, each of whose respective member parameter sets are respectively ranked in order based on a ranking input, utilizing respective filtered images, and from each of which an optimal parameter set is selected, based on a selection input, and used as a point of departure for deriving the next following plurality of parameter sets in the parameter space, in accordance with the preceding ranking, in conjunction with a step size and a step direction derived from the ranking, in accordance with multidimensional scaling (MDS).

In accordance with another aspect of the invention, the successive pluralities of parameter sets are derived by utilizing reconstruction of data sets of the plurality of parameter sets in a lower-dimensional space, while optimally preserving ranking and mutual distances, considered in a least-squares sense.

In accordance with another aspect of the invention, a method for interactively optimizing parameters in a parameter set for controlling an image filtering algorithm, comprises: inputting an original image to the image filtering algorithm; deriving successive pluralities of parameter sets in a parameter space; deriving a plurality of filtered images from the original image, corresponding respectively to each parameter set; ranking the plurality of images in descending order based on a ranking input and designating a first top-ranking image; starting with a parameter set corresponding to the first top-ranking image, as a point of departure for deriving a next succeeding plurality of parameter sets in the parameter space, in accordance with the ranking, in conjunction with a step size and a step direction derived from the ranking, in accordance with multidimensional scaling (MDS); deriving a second plurality of filtered images from the original image, corresponding respectively to each parameter set of the succeeding plurality; ranking the second plurality of images in descending order based on a ranking input and designating a second top-ranking image; and starting with a parameter set corresponding to the second top-ranking image, proceeding analogously, mutatis mutandis, as follows starting with the first top-ranking image until sufficient iterations are made to determine a best one of the top-ranking images.

In accordance with another aspect of the invention, method for interactively optimizing parameters in a parameter set for controlling an image filtering algorithm, comprising deriving a first plurality of parameter sets in a parameter space from a given parameter set for controlling the image filtering algorithm; inputting an initial image for filtering by the image filtering algorithm for deriving a first plurality of filtered images from the initial image, each corresponding to a respective parameter set of the first plurality of parameter sets; ranking images of the first plurality of filtered images in descending order of optimality, whereof the topmost image is selected as a first optimal image; and including in a first iteration: deriving a second plurality of parameter sets from the first plurality of parameter sets beginning with the parameter set corresponding to the first optimal image as a first starting parameter set in a parameter space, wherein other parameter sets of the second plurality are placed in the parameter space, using information from the ranking images of the first plurality of filtered images, the ranking being weighted such that placement of parameter sets of the second plurality in accordance with multi-dimensional scaling so as to increase a likelihood of the other parameter sets of the second plurality including a parameter representing an optimal image in a next iteration of ranking and selection; deriving a second plurality of filtered images from the second plurality of parameter sets, each corresponding to a respective parameter set of the second plurality of parameter sets, and ranking images of the second plurality of filtered images in descending order of optimality, whereof the topmost image is selected as a second optimal image.

In accordance with another aspect of the invention, a method for interactively optimizing parameters for controlling an image filtering algorithm, comprises: inputting an image to the image filtering algorithm; deriving a plurality of parameter sets from a given parameter set in accordance with multi-dimensional scaling (MDS); deriving a plurality of filtered images from the image filtering algorithm under control of the plurality of parameter sets, each filtered image being associated with a respective parameter set of the plurality of parameter sets; selecting an optimal filtered image from the plurality of filtered images; and ranking the remainder of the filtered images of the plurality in descending order of optimality.

In accordance with another aspect of the invention, a method for interactively optimizing parameters in a parameter set for controlling an image filtering algorithm, comprises: (a) generating a plurality of parameter sets by varying parameters in a parameter set in accordance with multi-dimensional scaling (MDS); (b) generating a plurality of filtered images corresponding respectively to parameter sets of the plurality of parameter sets; (c) selecting an optimal image from the plurality of filtered images, the optimal image corresponding to an optimal parameter set; (d) ending with the optimal image if a given criterion is met, and if not, then going to step (e); (e) deriving a further plurality of parameter sets by varying parameters of the optimal parameter set; (f) generating a further plurality of filtered images corresponding respectively to parameter sets of the further plurality of parameter sets; (g) selecting a further optimal image from the further plurality of filtered images, the further optimal image corresponding to a further optimal parameter set; and (h) ending with the further optimal image if the criterion is met; and if not, then (i) repeatedly performing, mutatis mutandis, the steps (e), (f), (g), and (h), with a yet further plurality of parameter sets in place of the further plurality of parameter sets, a yet further plurality of filtered images in place of the plurality of filtered images, and a yet further optimal image corresponding to a yet further optimal parameter set, until ending with a last further optimal image when the criterion is met.

In accordance with another aspect of the invention, a method for interactively optimizing parameters for controlling an image filter, comprises: deriving parameters from a first parameter set in accordance with multi-dimensional scaling (MDS) for providing a first plurality of parameter sets to the image filter; deriving a first plurality of filtered images from the image filter corresponding to respective parameter sets of the first plurality; selecting a first optimal image out of the filtered images, the first optimal image corresponding to a respective parameter set, hereinafter referred to as a first optimal parameter set; deriving parameters from the first optimal parameter set for providing a second plurality of parameter sets to the image filter; and deriving a second plurality of filtered images from the image filter corresponding to respective parameter sets of the second plurality.

In accordance with another aspect of the invention, a method for interactively optimizing parameters for controlling an image filter, comprises: providing a first plurality of parameter sets to the image filter; deriving a first plurality of filtered images from the image filter each corresponding to a respective parameter set of the first plurality of parameter sets; selecting a first optimal image out of the first plurality of filtered images, the first optimal image corresponding to a respective parameter set, hereinafter referred to as a first optimal parameter set; providing a second plurality of parameter sets to the image filter by deriving parameters from the first optimal parameter set by using multi-dimensional scaling (MDS), the second plurality of parameter sets in including the optimal parameter set; and deriving a second plurality of filtered images from the image filter corresponding to respective parameter sets of the second plurality.

In accordance with another aspect of the invention, a method for interactively optimizing parameters for controlling an image filtering algorithm, comprises: inputting an image to the image filtering algorithm; designating a number of parameter sets in a plurality of parameter sets; designating a number of dimensions in each parameter; representing in a multi-dimensional parameter space the number of parameter sets; deriving a plurality of parameter sets from a given parameter set in accordance with multi-dimensional scaling (MDS); deriving a plurality of filtered images from the image filtering algorithm under control of the plurality of parameter sets, each filtered image being associated with a respective parameter set of the plurality of parameter sets; selecting an optimal filtered image from the plurality of filtered images, the optimal filtered image being associated with a parameter set hereinafter referred to as an optimal parameter set; ranking the remainder of the filtered images of the plurality in descending order of optimality; utilizing information from the step of selecting an optimal filtered image from a plurality of filtered images and ranking the remainder of the filtered images of the plurality according to variation from the optimal image, to determine a search step size, determine a center for a search, and determine a search direction; deriving a second plurality of parameter sets from the optimal parameter set, by using the search step size, the center for a search, and the search direction; deriving a second plurality of filtered images from the image filtering algorithm under control of the second plurality of parameter sets, each filtered image of the second plurality being associated with a respective parameter set of the second plurality of parameter sets; selecting a second optimal filtered image from the second plurality of filtered images and ranking the remainder of the filtered images of the second plurality in descending order of optimality, the second optimal filtered image being associated with a parameter set hereinafter referred to as an optimal parameter set; utilizing information from the step of selecting a second optimal filtered image from the plurality of filtered images and ranking the remainder of the second plurality of filtered images according to variation from the optimal image, to determine a second search step size, determine a second center for a search, and determine a second search direction; and deriving a third plurality of parameter sets from the second optimal parameter set, by using the second search step size, the second center for a search, and the second search direction.

In accordance with another aspect of the invention, a method for interactively optimizing parameters in a parameter set, comprises: deriving a plurality of parameter sets in a parameter space, from an initial parameter set; selecting an optimal parameter set of the plurality; ranking the remaining parameter sets in descending order from the optimal parameter set; starting with the optimal parameter set as a center in the parameter space, deriving a step size and a step direction from the ranking, in accordance with multidimensional scaling (MDS); deriving a further plurality of parameter sets in the parameter space, in accordance with the center, the step size, and the direction while preserving the ranking; selecting a further optimal parameter set of the further plurality; ranking the remaining parameter sets of the further plurality in descending order from the optimal parameter set; and starting from the further optimal parameter set as a center in place of the optimal parameter set, iterating the subsequent steps until a best one of the optimal parameter sets is reached.

In accordance with another aspect of the invention, a system for interactively optimizing performance of a system comprises: means for interactively adjusting controlling parameters in a parameter set, by deriving successive pluralities of parameter sets in a parameter space, each of whose respective member parameter sets are respectively ranked in order, means for utilizing a ranking input based on respective system performance associated with each parameter set and means for selecting from each of which plurality of parameter sets an optimal parameter set and using the optimal parameter set as a point of departure for deriving the next following plurality of parameter sets in the parameter space, in accordance with the preceding ranking, in conjunction with a step size and a step direction derived from the ranking, in accordance with multidimensional scaling (MDS).

In accordance with another aspect of the invention a system for optimizing performance of a system, comprises: means for interactively adjusting controlling parameters in a parameter set comprising respective member parameter sets, the means comprising: means for deriving successive pluralities of parameter sets in a parameter space; means for ranking each of the respective member parameter sets in order, utilizing a ranking input based on respective system performance associated with each parameter set; means for selecting an optimal parameter set from the plurality of parameter sets: and means for using the optimal parameter set as a point of departure for deriving a next following plurality of parameter sets in the parameter space, in accordance with the preceding ranking, in conjunction with a step size and a step direction derived from the ranking, in accordance with multidimensional scaling (MDS).

In accordance with another aspect of the invention a system for optimizing performance of a system, comprises: means for interactively adjusting controlling parameters in a parameter set comprising respective member parameter sets, the adjusting comprising: means for deriving a first plurality of parameter sets in a parameter space from a given parameter set for controlling the system; means for ranking each of the respective parameter sets in order, utilizing a ranking input based on respective system performance associated with each parameter set, wherein a topmost ranked parameter set is selected as a first optimal parameter set; and means for using the optimal parameter set as a point of departure for deriving a next following plurality of parameter sets in the parameter space, in accordance with the preceding ranking, in conjunction with a step size and a step direction derived from the ranking, in accordance with multidimensional scaling (MDS).

In accordance with another aspect of the invention, a system for interactively optimizing a system comprises means for interactively adjusting controlling parameters in a parameter set, by deriving successive pluralities of parameter sets in a parameter space, each of whose respective member parameter sets are respectively ranked in order, utilizing a ranking input based on respective system performance associated with each parameter set and from each of which plurality of parameter sets an optimal parameter set is selected and used as a point of departure for deriving the next following plurality of parameter sets in the parameter space, in accordance with the preceding ranking, in conjunction with a step size and a step direction derived from the ranking, in accordance with multidimensional scaling (MDS).

In accordance with another aspect of the invention a computer program product comprising a computer useable medium having computer program logic recorded thereon for program code for optimizing a system, comprises: interactively adjusting controlling parameters in a parameter set comprising respective member parameter sets, the adjustment comprising: deriving successive pluralities of parameter sets in a parameter space; ranking each of the respective member parameter sets in order, utilizing a ranking input based on respective system performance associated with each parameter set; selecting an optimal parameter set from the plurality of parameter sets: and using the optimal parameter set as a point of departure for deriving a next following plurality of parameter sets in the parameter space, in accordance with the preceding ranking, in conjunction with a step size and a step direction derived from the ranking, in accordance with multidimensional scaling (MDS).

### BRIEF DESCRIPTION OF THE SEVERAL VIEWS OF THE DRAWINGS

The invention will be more fully understood from the following detailed description, in conjunction with the drawings, in which

FIG. 1 shows a schematic block diagram in accordance with principles of the invention;

FIG. 2 shows a graphical rendering, helpful to an understanding of a per se prior art method of optimization;

FIG. 3 shows a graphical representation of operations in a parameter space in accordance with the principles of the present invention; and

FIGS. 4 through 7 show a graphical presentation of experimental results obtained in accordance with various optimization criteria, providing a basis for comparison of the present invention with other methods.

### DETAILED DESCRIPTION OF THE INVENTION

While the present invention is broadly applicable to optimizing systems in general, it is also helpful to explain the invention and its principles herein by way of exemplary embodiments, without loss of generality. An important field of application for the present invention relates to image optimization. The following exemplary embodiments relate to image optimization by way of optimizing sets of parameters controlling an image filter.

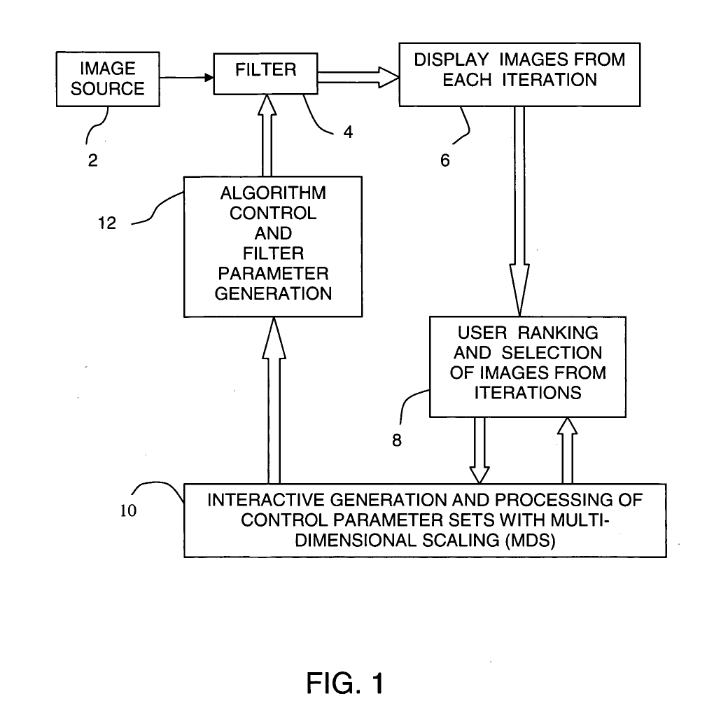

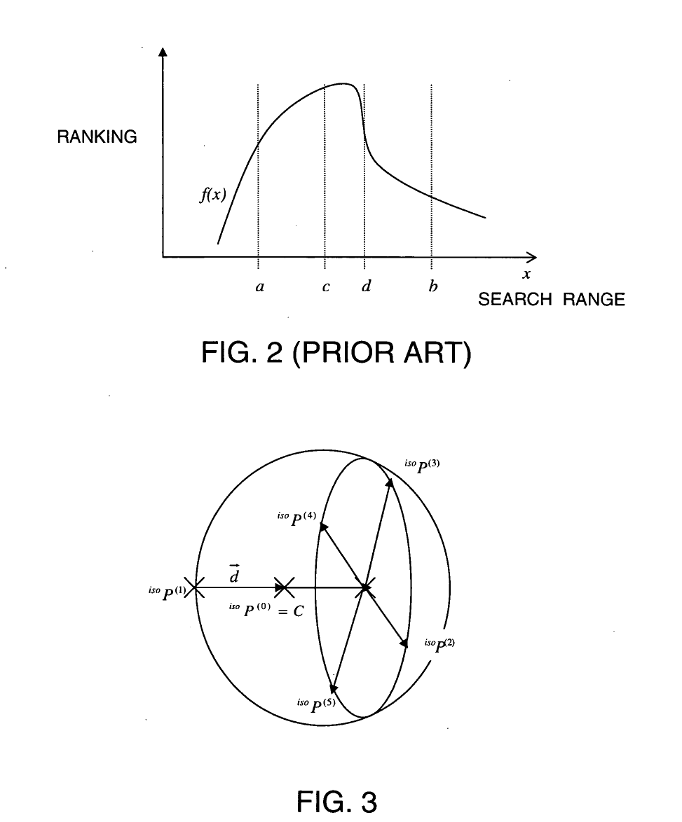

FIG. 1 shows a schematic block diagram in accordance with principles of the invention, in which an image is provided from an image source 2 and supplied to an image filter 4. It will be understood that filter 4, as with other elements shown in the figure, is best implemented in software, using a programmable digital computer. It may possibly also be implemented in a combination of dedicated hardware and software, though this is more cumbersome and not as convenient, especially in the present case where the filter coefficients are being changed to provide adaptive filtering.

From image filter 4, filtered images are inputted to a display device 6 which includes an associated memory for image and data storage. In the preferred embodiment with a programmed computer, a portion of the computer memory will serve as the image memory for a display device for presenting images to a user. Filtered image ranking and selection of optimal filtered images is represented in block 8 which exchanges data with block 10 which represents the interactive generation and processing of control parameters which, in conjunction with filtering algorithm control and filter parameter generation block 12, control the generation of appropriate control parameters by which filter 4 is controlled.

The method in accordance with the present invention fully explores the abundant information in the ratings and their relative order. In every iteration, a center point, a direction and a step size are computed from the feedback. The direction is computed such that the ranking of the points onto the direction is preserved, and the mutual distances are preserved as well as possible. Accordingly this technique is referred to as Multidimensional Scaling (MDS). MDS allows the reconstruction of a data set in a less-dimensional or lower-dimensional space, which optimally preserves the mutual distances, considered in a least-squares sense.

Varying all five dimensions at a time was found to produce the best results in the experimental work performed. A clearly defined configuration of the points in the parameter space is required to simultaneously update the center, the step size and the direction.

The algorithm in accordance with the present invention works in two steps: first, the step size s, the center C and the direction \vec{d} are computed, using feedback from the user. Thereafter, six points are calculated from the three given iteration parameters.

The iteration parameters s, C and \vec{d} are next considered. The method chosen to update the step size is straightforward: if the center point gets the best rating, the step size is divided by 2, leading to a convergence around the best point. If a different point yields the best rating and the best point in the previous round or iteration was not the center point, the step size is multiplied by 1.25, so as to try to recover from an excessive amount of shrinking in a previous step. Otherwise, the step size stays unchanged. Clearly, in various other applications, different values may be appropriate.

The center point is always set to the point with the best rating. The best point of the previous iteration is thus always shown, thereby allowing comparison between different iterations.

An important part of the algorithm in accordance with the present invention is the generation of the next direction, for which the afore-mentioned multidimensional scaling (MDS) technique is used. A general introduction to MDS and some applications can be found in Introduction to the MDS technique by StatSoft, available at http://www.statsoft.com/textbook/stmulsca.html.

The implementation was done in accordance with D. Becker: Material to the course Learning from Data I at Edinburgh University School of Informatics, 2004. Available online at http://www.anc.ed.ac.uk/˜dbarber/lfd1/lfd1_{—}2003_visual.pdf.

Let the points be given as P⁽ⁱ⁾ with coordinates Pⱼ⁽ⁱ⁾ and ratings r⁽ⁱ⁾, with 0≦i<p and 0≦j<n. In the case of the present embodiment of the invention and the experimental verification, the number of points, p, is usually 6, and the number of dimensions, n, is usually 5. Clearly other numbers may be used depending upon the application.

The differences between the ratings of the image are interpreted as distances between the respective points in the parameter space. As first step, the p×p distance matrix D (Euclidian Distance) is computed as follows:
Dₖₗ=(r^{(k)}−r^{(l)})².

The auxiliary matrix M is calculated with the elements

$${M}_{ab} = - \frac{1}{2} ( {D}_{ab} - \frac{1}{p} {\sum }_{a} {D}_{ab} + \frac{1}{{p}^{2}} {\sum }_{a , b} {D}_{ab} - \frac{1}{p} {\sum }_{b} {D}_{ab} ) .$$

A singular value decomposition of M is made, yielding the eigenvalues λ⁽ⁱ⁾ and the corresponding eigenvectors \vec{e⁽ⁱ⁾}. In the given setting, only the dimension with the largest eigenvalue is chosen, and the new direction based on multidimensional scaling is
\vec{d}=\vec{e⁽¹⁾}
where \vec{d} is a unit vector (i.e. |\vec{d}|=1). Unless the user sets the step size, a minimum criterion ensures a non-zero step size in every direction.

The points on a hyper-sphere are next considered. Given the step size s, the center C and the direction \vec{d}, the six parameter sets for the next iteration are computed. In a first step, all the computations are done in an isotropic space, where the length unit is the same for all dimensions. The points are set on a sphere with center Cₛ=(0,0,0,0,0) and radius 1, the placement depending only on \vec{d} and the previous direction.

Afterwards, the points are transformed into the anisotropic parameter space, deforming the sphere into a five-dimensional ellipsoid. At this point, the center C, the step size s and the different range of the parameters (which actually causes the anisotropy) are taken into account.

Computation in the isotropic space is considered next. All points in the isotropic space will be indexed with ^{iso}. The first point is the center of the sphere: ^{iso}P⁽⁰⁾=(0;0;0;0;0).

The second point is given by the direction \vec{d}: ^{iso}P⁽¹⁾=^{iso}P⁽⁰⁾+\vec{d}=(d₁;d₂;d₃;d₄;d₅), and the third point is given by a combination of the last direction and the current one:

$${}^{iso} {P}^{( 2 )} {=}^{iso} {P}^{( 0 )} + \vec{k} , with \vec{k} = \frac{\frac{\vec{d}}{4} + \vec{{d}_{prev}}}{\vert \frac{\vec{d}}{4} + \vec{{d}_{prev}} \vert} .$$

For the rest of the points, three unit vectors \vec{r₁}, \vec{r₂}, \vec{r₃} are chosen randomly, observing a minimal angle of 72° (being the division of 360° by 5) between every pair of them as well as between any of them and \vec{d} and \vec{k}. Mathematically formulated, these conditions are:
|\vec{r₁}|=|\vec{r₂}|=|\vec{r₃}|=1
\vec{rᵢ}·\vec{k}≦cos (72°), i=1, 2, 3
\vec{rᵢ}·\vec{d}≦cos (72°), i=1, 2, 3
\vec{rᵢ}·\vec{rⱼ}≦cos (72°), i, j=1, 2, 3 and i≠j.

The minimal angles ensure a sufficient difference of the parameter points and the corresponding images. The chosen values yielded the best results. These vectors are used to define the remaining three points: ^{iso}P⁽³⁾=^{iso}P⁽⁰⁾+\vec{r₁}, ^{iso}P⁽⁴⁾=^{iso}P⁽⁰⁾+\vec{r₂} and ^{iso}P⁽⁵⁾=^{iso}P⁽⁰⁾+\vec{r₃}.

Computation in the case of decreased dimensionality is next considered. In the case where the user has set the direction in two or more directions to 0, other methods to generate the points in the isotropic space are used: As in the usual case, the first point, ^{iso}P⁽⁰⁾, is set to the center: ^{iso}P⁽⁰⁾=(0;0;0;0;0). The placement of the other points depends on the number of dimensions with non-zero step size.

In the case where no dimension has a non-zero step size: if all parameters have zero step size, nothing can be done, as the direction vector is identical to the zero-vector. All points are set to the center: ^{iso}P⁽ⁱ⁾=^{iso}P⁽⁰⁾, i=1 . . . p−1.

Considering the case of one dimension with non-zero step size: if one parameter has non-zero step size, the five points are computed in adaptation of the idea of the aforementioned Brent's Golden Section Search. The new points are the following ones:
^{iso}P⁽¹⁾=^{iso}P⁽⁰⁾+φ·\vec{d}
^{iso}P⁽²⁾=^{iso}P⁽⁰⁾−φ·\vec{d}
^{iso}P⁽³⁾=^{iso}P⁽⁰⁾+\vec{d}
^{iso}P⁽⁴⁾=^{iso}P⁽⁰⁾−\vec{d}
^{iso}P⁽⁵⁾=^{iso}P⁽⁰⁾+(1+φ)·\vec{d}
where φ denotes the golden section:

$$φ = \frac{\sqrt{5} - 1}{2} \approx 0.618034 .$$

Considering next the case of two dimensions with non-zero step size: in the case of two varying parameters, a circle is defined by the center and the direction. The first point ^{iso}P⁽¹⁾ on the circle is computed as ^{iso}P⁽¹⁾=^{iso}P⁽⁰⁾−\vec{d}, the other four are rotations of ^{iso}P⁽¹⁾ of 72° around the center.

In the case of three dimensions with non-zero step size: if three parameters have non-zero variation, an equilateral tetrahedron is herein recognized to be a convenient and useful shape. See FIG. 3. The first point ^{iso}P⁽¹⁾=^{iso}P⁽⁰⁾−\vec{d} is the apex; the other four points lie on a plane that would correspond to the ground plane of a tetrahedron. Its middle point, herein called M, is M=C+⅓·\vec{d}

From the middle point M of the ground plane, four vectors orthogonal to \vec{d} lead to the remaining points. The vector to P₂ is chosen such that the two components with the biggest step sizes are parallel to the direction of the last step. Together with the length condition (\vec{^{iso}P^{(0) iso}P⁽²⁾} has the same length as \vec{d}) and the perpendicularity between \vec{M^{iso}P⁽²⁾} and \vec{d}, these conditions determine this first vector and thus ^{iso}P⁽²⁾. ^{iso}P⁽⁴⁾ is ^{iso}P⁽²⁾ reflected on M.

For the two remaining points, the vectors are chosen to be rectangular to the previously generated, i.e. \vec{M^{iso}P⁽³⁾} is rectangular to \vec{M^{iso}P⁽²⁾}. Again, the two other conditions (\vec{M^{iso}P⁽³⁾} rectangular to \vec{d}, \vec{^{iso}P^{(0) iso}P⁽³⁾} has the same length as \vec{d}) determine \vec{M^{iso}P⁽³⁾} and thus ^{iso}P⁽³⁾. ^{iso}P⁽⁵⁾ is the reflection of ^{iso}P⁽³⁾ on M.

Mapping to the real parameter space is next considered. In the second step, the points in the isotropic space are mapped into the anisotropic parameter space. The step size s is used to determine the size of the sphere, and the initial parameter directions determine the anisotropy of the space.

The formula used for this mapping is the following:
Pⱼ⁽ⁱ⁾=C+s·(\vec{dᵢₙᵢₜ})ⱼ·^{iso} Pⱼ⁽ⁱ⁾
where (\vec{dᵢₙᵢₜ})ⱼ denotes the j-th component of the initial direction. In order to keep the best image of the previous round (which is now the center) stays at its position, a permutation of the point numbering is done at the same time.

Numerical experiments have been carried as will be described next. All implemented methods have been tested with the two different variants of feedback (click feedback or full numerical feedback) and two different filter algorithms on two ultrasound images.

For the click feedback, the filtered images were compared with the given reference image, and the one with the least difference was clicked (that is, selected to be the best one). As the feedback was given after every iteration (that is, after every set of images), this rating technique is only applicable to the two aforementioned algorithms that do not need immediate feedback: Normal Distribution and Multidimensional Scaling.

For the full feedback, a function was used to generate the rating from the distance to the reference image. The feedback was generated immediately after the filtering, thus allowing comparison of all four implemented search algorithms. However, the Normal Distribution and the Multidimensional Scaling work in rounds with a number of points that corresponds to the number of images displayed per iteration.

For every method, the quality of the best image so far was measured and tracked as a function of the number of iterations (for the click feedback) or the number of generated images (for the immediate, full rating). As a quality measure, the difference of the filtered image img to a given reference (or golden standard) image ref was taken: The quality is given by the average pixel-wise square distance between img and ref:

$${\overline{d}}_{2} ( img ) = \sqrt{\frac{1}{h \cdot w} {\sum }_{x = 0}^{w - 1} {\sum }_{y = 0}^{h - 1} {( {img}_{x , y} - {ref}_{x , y} )}^{2}} ,$$

where h is the height, w the width of the images and img_{x,y} is the gray scale value of the pixel at position (x,y) in the image img. The size of the reference image is preferably always the same as that of the filtered image.

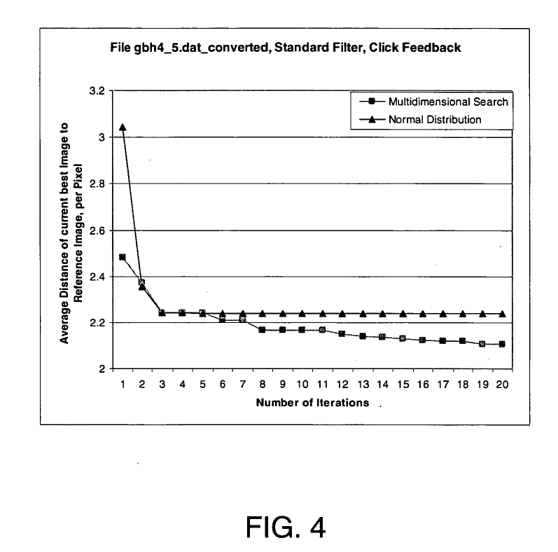

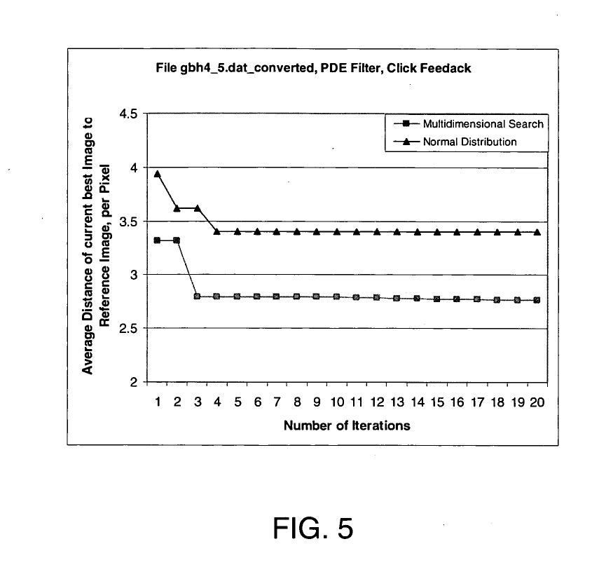

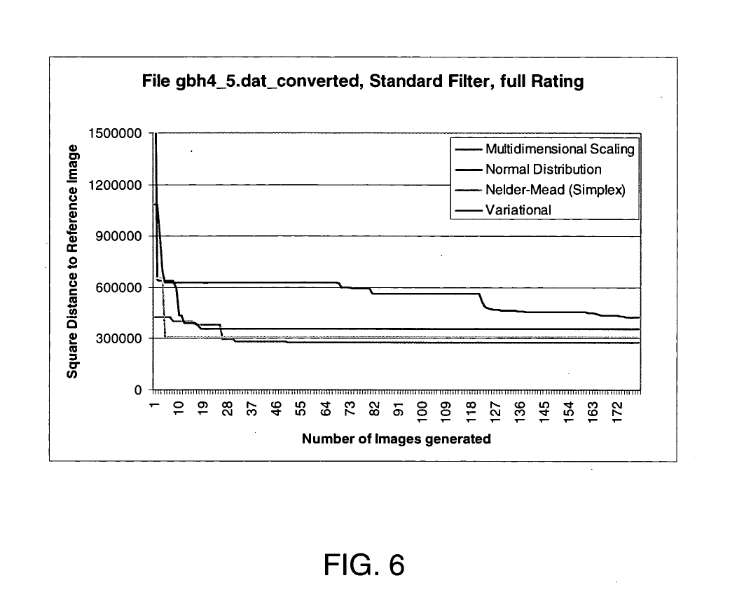

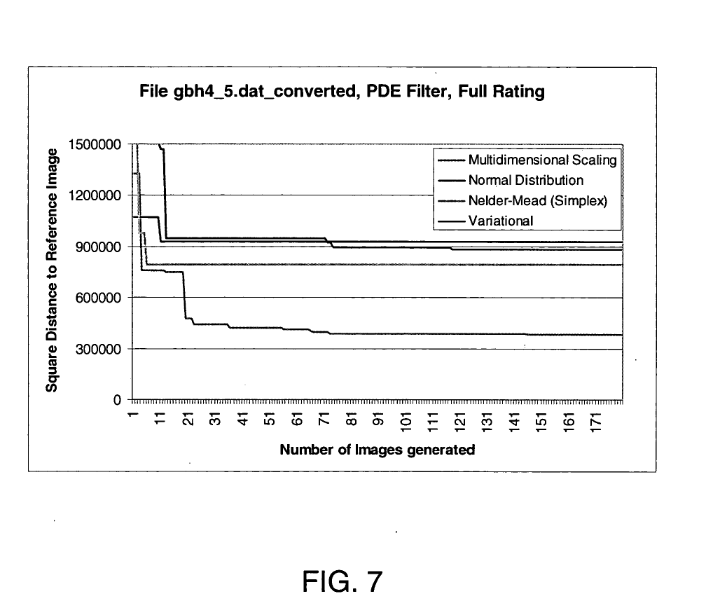

FIG. 4 shows results using a standard filter and click feedback; FIG. 5 shows results with a Partial Differential Equation (PDE) filter and click feedback; FIG. 6 shows results using a standard (adaptive) filter and full numerical rating for all images of a current set; and FIG. 7 shows results using a PDE filter and full numerical rating for all images of a current set. The PDE filter is appropriate to this exemplary implementation of the method of the present invention; however, other types of filter may also be used.

In the vast majority of cases, the parameters based on the Multidimensional Scaling method in accordance with the present invention produced the best results. A noticeable difference is observed between the two filter methods: while all parameter generation methods produced similar results in the first few iterations when using the standard filter, big differences are observed when the PDE filter is used. In this case, the MDS produced significantly better parameters than all other methods. For both algorithms, major improvement takes place during the first few iterations; the MDS method steadily finds new best results, whereas the best result found using the normal distribution method only improves a little after this first phase.

In the case of the click feedback on the standard filter, the normal distribution and the MDS parameters are about the same in the first five iterations; afterwards, the values generated by MDS are better. The number of iterations corresponds to the number of feedbacks given by the user; in every iteration in the present example, a set of typically six images is generated.

In the case of full, numerical rating for all images of the current set, all four algorithms except the variational method produce similar results in the case of the standard filter. If the PDE filter is used, the MDS based parameters get the best ratings, with the results from the other three methods being in the same range. Again, the major improvement is done after about thirty images, which results in a similar number of images as in the case of the click rating.

Comparing the overall behavior, the distance of the current best image after a given number of generated images is about ten percent lower in the case of full rating, compared to the click rating. The difference of the results is thus not as big as might have been expected.

As will be apparent, the present invention is intended to be implemented with the use and application of a programmed digital computer. Inputs may be made directly, or by communication with another computer or device by way of direct connection, a modulated infrared beam, radio, land line, facsimile, or satellite as, for example, by way of the World Wide Web or Internet, or any other appropriate source of such data. The output device may include a computer type display device using any suitable apparatus such as a cathode-ray kinescope tube, a plasma display, liquid crystal display, and so forth, or it may include memory for storing an image for further processing, or for viewing, or evaluation, as may be convenient, or it may utilize a connection or coupling including such as are noted above in relation to the input. The processor is operative with a program set up in accordance with the present invention for implementing steps of the invention. Such a programmed computer may interface readily through communications media such as land line, radio, the Internet, and so forth for image data acquisition and transmission.

The invention may be readily implemented, at least in part, in a software memory device and packaged in that form as a software product. This can be in the form of a computer program product comprising a computer useable medium having computer program logic recorded thereon for program code for performing the method of the present invention.

The present invention has also been explained in part by way of examples using illustrative exemplary embodiments. It will be understood that the description by way of exemplary embodiments is not intended to be limiting and that, while the present invention is broadly applicable to optimizing systems in general, it is helpful to also illustrate its principles, without loss of generality, by way of exemplary embodiments relating to an important field of application for the present invention, namely, to image optimization. It will also be understood that various changes and substitutions not herein explicitly described may be made without departing from the spirit and scope of the invention which is defined by the claims following.

What is claimed is:

1. A method for interactively optimizing parameters in a parameter set, comprising: deriving successive pluralities of parameter sets in a parameter space, each of whose respective member parameter sets are respectively ranked in order based on a ranking input, and from each of which an optimal parameter set is selected and used as a point of departure for deriving in a next iteration, the next following plurality of parameter sets in said parameter space, in accordance with said ranking input in the preceding iteration, in conjunction with a step size and a step direction derived from said ranking input, in accordance with multidimensional scaling (MDS).

2. A method for interactively optimizing a system comprising: interactively adjusting controlling parameters in a parameter set, by deriving successive pluralities of parameter sets in a parameter space, each of whose respective member parameter sets are respectively ranked in order, utilizing a ranking input based on respective system performance associated with each parameter set and from each of which plurality of parameter sets an optimal parameter set is selected and used as a point of departure for deriving the next following plurality of parameter sets in said parameter space, in accordance with said preceding ranking, in conjunction with a step size and a step direction derived from said ranking, in accordance with multidimensional scaling (MDS).

3. A method for optimizing a system, comprising:
interactively adjusting controlling parameters in a parameter set comprising respective member parameter sets, said adjustment comprising:
deriving successive pluralities of parameter sets in a parameter space;
ranking each of said respective member parameter sets in order, utilizing a ranking input based on respective system performance associated with each parameter set;
selecting an optimal parameter set from said plurality of parameter sets; and
using said optimal parameter set as a point of departure for deriving a next following plurality of parameter sets in said parameter space, in accordance with the preceding ranking, in conjunction with a step size and a step direction derived from the ranking, in accordance with multidimensional scaling (MDS).

4. A method as recited in claim 3, comprising deriving said successive pluralities of parameter sets by utilizing reconstruction of data sets of said plurality of parameter sets in a lower-dimensional space, while optimally preserving ranking and mutual distances, considered in a least-squares sense.

5. A method as recited in claim 4, comprising utilizing user input as said ranking input.

6. A method as recited in claim 5, comprising using comparisons with a desired standard as said ranking input.

7. A method for optimizing a system, comprising:
interactively adjusting controlling parameters in a parameter set comprising respective member parameter sets, said adjusting comprising:
deriving a first plurality of parameter sets in a parameter space from a given parameter set for controlling said system;
ranking each of said respective parameter sets in order, utilizing a ranking input based on respective system performance associated with each parameter set, wherein a topmost ranked parameter set is selected as a first optimal parameter set; and
using said optimal parameter set as a point of departure for deriving a next following plurality of parameter sets in said parameter space, in accordance with the preceding ranking, in conjunction with a step size and a step direction derived from the ranking, in accordance with multidimensional scaling (MDS).

8. A method in accordance with claim 7, including in a first iteration:
deriving a second plurality of parameter sets from said first plurality of parameter sets beginning with the said first optimal parameter set as a first starting parameter set in said parameter space, wherein other parameter sets of said second plurality are placed in said parameter space, using information from said ranking, said ranking being weighted for placement of parameter sets of said second plurality in accordance with multi-dimensional scaling so as to increase a likelihood of said other parameter sets of said second plurality including a parameter representing an optimal parameter in a next iteration of ranking and selection; and
ranking performance with said second plurality of parameter sets in descending order of optimality, whereof the topmost parameter set is selected as a second optimal parameter set.

9. A method in accordance with claim 8, including in a second iteration:
deriving a third plurality of parameter sets from said second plurality of parameter sets beginning with said second optimal parameter set as a second starting parameter set in said parameter space, and continuing in an analogous manner to selection of said second optimal parameter set to select a third optimal parameter set.

10. A method in accordance with claim 9, wherein a fourth, and optionally, further iterations are performed in accordance with the steps, mutatis mutandis, performed in the foregoing iteration.

11. A method in accordance with claim 8, wherein said parameter space is a multi-dimensional space.

12. A method in accordance with claim 9, wherein said parameter space is a multi-dimensional space.

13. A method in accordance with claim 8, wherein said step of deriving a second plurality of parameter sets comprises utilizing a multi-dimensional scaling algorithm designed to find an optimal search direction in said parameter space, which best preserves relative ranking between said parameter sets.

14. A method in accordance with claim 14, wherein said step of deriving a second plurality of parameter sets comprises computing from said ranking, a center point, a direction for placement of parameter sets and a step size for proceeding in said direction, computed from said ranking.

15. A method in accordance with claim 14, wherein said step of computing from said ranking, a center point, a direction for placement of parameter sets and a step size for proceeding in said direction is performed in each iteration.

16. A method in accordance with claim 15, wherein said step of computing a direction comprises a computing a direction for placement of said parameter sets such that ranking of parameter sets onto the direction vector is preserved, and mutual distances are preserved in an optimal manner.

17. A method in accordance with claim 16, wherein said parameter space is a multi-dimensional space.

18. A method in accordance with claim 17 comprising:
computing said step size, defined as s;
computing said center point, defined as C; and
computing said direction \vec{d}, all computations using feedback from said rankings.

19. A method in accordance with claim 18, wherein said center point is always set to a point with the best rating, whereby said point with the best rating is thus always shown, permitting comparison between different iterations.

20. A method in accordance with claim 19, comprising:
updating said step size in accordance with the following:
if said center point corresponds to an optimal ranking, then dividing said step size by 2, or
if a different point yields the best rating and the best point in the previous iteration was not the center point, multiplying said step size by 1.25 so as to tend to recover from any excessive amount of shrinking in a previous step, or
otherwise, said step size remains unchanged.

21. A method in accordance with claim 20, wherein said computing said direction \vec{d}, in accordance with multidimensional scaling (MDS), is performed as follows:
points in said parameter space be are given as P⁽ⁱ⁾ with coordinates Pⱼ⁽ⁱ⁾ and ratings r⁽ⁱ⁾, with 0≦i<p and 0≦j<n;
differences between the ratings of the parameter sets are interpreted as distances between the respective points in said parameter space;
computing a p×p distance matrix D, being a Euclidian Distance, as follows:
Dₖₗ=(r^{(k)}−r^{(l)})²;
computing an auxiliary matrix M with the elements
$${M}_{ab} = - \frac{1}{2} ( {D}_{ab} - \frac{1}{p} {\sum }_{a} {D}_{ab} + \frac{1}{{p}^{2}} {\sum }_{a , b} {D}_{ab} - \frac{1}{p} {\sum }_{b} {D}_{ab} ) ;$$
making a singular value decomposition of M, yielding the eigenvalues λ⁽ⁱ⁾ and the corresponding eigenvectors \vec{e⁽ⁱ⁾};
selecting, in a given setting, only the dimension with the largest eigenvalue and a new direction based on multidimensional scaling is
\vec{d}=\vec{e⁽¹⁾}
where \vec{d} is a unit vector (i.e. |\vec{d}|=1); and
setting a minimum criterion to ensures a non-zero step size in every direction, absent user input setting a step size.

22. A method in accordance with claim 21, wherein;
said number of points, p is taken as six (6) and said number of dimensions, n, is taken as five (5).

23. A method in accordance with claim 22, wherein placement of said points on a hyper-sphere is as follows:
computing six parameter sets for a next iteration, given a step size s, a center C and a direction \vec{d};
as a first step, said computing is performed is done in an isotropic space, wherein a length unit is the same for all dimensions;
said points are set on a sphere with center Cₛ=(0,0,0,0,0) and radius 1, said placement depending only on \vec{d} and the previous direction;
indexing all points in said isotropic space with ^{iso}:
the first point is the center of the sphere: ^{iso}P⁽⁰⁾=(0;0;0;0;0),
the second point is given by the direction \vec{d}:
^{iso}P⁽¹⁾=^{iso}P⁽⁰⁾+\vec{d}=(d₁;d₂;d₃;d₄;d₅), and
the third point is given by a combination of the last direction and the current one:
$${}^{iso} {P}^{( 2 )} {=}^{iso} {P}^{( 0 )} + \vec{k} , with \vec{k} = \frac{\frac{\vec{d}}{4} + \vec{{d}_{prev}}}{\vert \frac{\vec{d}}{4} + \vec{{d}_{prev}} \vert} ;$$
for the rest of said points, randomly selecting three unit vectors \vec{r₁}, \vec{r₂}, \vec{r₃}, observing a minimal angle of 72°, corresponding to a division of 360° by 5 or, in the alternative, a corresponding division by another number of points, between every pair of them as well as between any of them and \vec{d} and \vec{k}, which conditions are formulated as follows:

|\vec{r₁}|=|\vec{r₂}|=|\vec{r₃}|=1
\vec{rᵢ}·\vec{k}≦cos (72°), i=1, 2, 3
\vec{rᵢ}·\vec{d}≦cos (72°), i=1, 2, 3
\vec{rᵢ}·\vec{rⱼ}≦cos (72°), i, j=1, 2, 3 and i≠j,
said minimal angles ensuring a sufficient difference of said parameter points and the corresponding parameter sets; and
defining the remaining three points: ^{iso}P⁽³⁾=^{iso}P⁽⁰⁾+\vec{r₁}, ^{iso}P⁽⁴⁾=^{iso}P⁽⁰⁾+\vec{r₂} and ^{iso}P⁽⁵⁾=^{iso}P⁽⁰⁾+\vec{r₃} by these vectors.

24. A method in accordance with claim 23, wherein:
generating the points in said isotropic space in the case of decreased dimensionality is performed alternatively as follows:
in the case where a user has set the direction in two or more directions to 0, the first point, ^{iso}P⁽⁰⁾, is set to the center: ^{iso}P⁽⁰⁾=(0;0;0;0;0);
placing the other points, depending on the number of dimensions with non-zero step size, as follows:
where no dimension has a non-zero step size: f, all parameters have zero step size, nothing further is done, as the direction vector is identical to the zero-vector and all points are set to the center: ^{iso}P⁽ⁱ⁾=^{iso}P⁽⁰⁾, i=1 . . . p−1;
in the case of one dimension with non-zero step size: if one parameter has non-zero step size, the five points, or another number where the number of points selected is different, in are computed in an adaptation of Brent's Golden Section Search.

25. A method in accordance with claim 24, wherein:
new points in accordance with said adaptation Brent's Golden Section Search are the following:
^{iso}P⁽¹⁾=^{iso}P⁽⁰⁾+φ·\vec{d}
^{iso}P⁽²⁾=^{iso}P⁽⁰⁾−φ·\vec{d}
^{iso}P⁽³⁾=^{iso}P⁽⁰⁾+\vec{d}
^{iso}P⁽⁴⁾=^{iso}P⁽⁰⁾−\vec{d}
^{iso}P⁽⁵⁾=^{iso}P⁽⁰⁾+(1+φ)·\vec{d}
wherein φ denotes the golden section:
$$φ = \frac{\sqrt{5} - 1}{2} \approx 0.618034 .$$

26. A method in accordance with claim 25 wherein:
in the case of two dimensions with non-zero step size: in the case of two varying parameters, wherein a circle is defined by its center and the direction, computing said first point ^{iso}P⁽¹⁾ on said circle as ^{iso}P⁽¹⁾=^{iso}P⁽⁰⁾−\vec{d}; and
the other four being rotations of ^{iso}P⁽¹⁾ of 72° around said center.

27. A method in accordance with claim 26, wherein:
in the case of three dimensions with non-zero step size: if three parameters have non-zero variation, utilizing an equilateral tetrahedron wherein said first point ^{iso}P⁽¹⁾=^{iso}P⁽⁰⁾−\vec{d} being the apex; the other four points lying on a plane corresponding to the ground plane of a tetrahedron, whereof the middle point is herein called M, is M=C+⅓·\vec{d}, and from said middle point M of said ground plane, four vectors orthogonal to \vec{d} lead to the remaining points:
selecting a first vector to P₂ such that the two components with the biggest step sizes are parallel to the direction of the last step;
determining said vector by the following the length condition (\vec{^{iso}P^{(0) iso}P⁽²⁾} has the same length as \vec{d}) and the condition of the perpendicularity between \vec{M^{iso}P⁽²⁾} and \vec{d}, and thus ^{iso}P⁽²⁾. ^{iso}P⁽⁴⁾ is ^{iso}P⁽²⁾ reflected on M; and
for the two remaining points, choosing the vectors to be orthogonal to the previously generated vectors, that is, \vec{M^{iso}P⁽³⁾} is rectangular to \vec{M^{iso}P⁽²⁾}, and, wherein, subject to the two other conditions (\vec{M^{iso}P⁽³⁾} rectangular to \vec{d}, \vec{^{iso}P^{(0) iso}P⁽³⁾} has the same length as \vec{d}) determine \vec{M ^{iso}P⁽³⁾} and ^{iso}P⁽³⁾. ^{iso}P⁽⁵⁾ is thus the reflection of ^{iso}P⁽³⁾ on M.

28. A method in accordance with claim 26, including:
mapping said points in an isotropic parameter space into an anisotropic parameter space by:
deforming said hyper-sphere into a five-dimensional ellipsoid, taking into account said center C;
utilizing said step size s to determine the size of said sphere; and
initial parameter directions determine the anisotropy of said anisotropic parameter space.

29. A method in accordance with claim 28, wherein said mapping said points in an isotropic parameter space into an anisotropic parameter comprises:
mapping in accordance with the following formula:
Pⱼ⁽ⁱ⁾=C+s·(\vec{dᵢₙᵢₜ})ⱼ·^{iso}Pⱼ⁽ⁱ⁾
wherein (\vec{dᵢₙᵢₜ})ⱼ denotes the j-th component of said initial direction.

30. A method in accordance with claim 29, including performing a permutation of the point numbering.

31. A method for interactively optimizing parameters in a parameter set for controlling an image filtering algorithm, comprising deriving successive pluralities of parameter sets in a parameter space, each of whose respective member parameter sets are respectively ranked in order based on a ranking input, utilizing respective filtered images, and from each of which an optimal parameter set is selected, based on a selection input, and used as a point of departure for deriving the next following plurality of parameter sets in said parameter space, in accordance with the preceding ranking, in conjunction with a step size and a step direction derived from said ranking, in accordance with multidimensional scaling (MDS).

32. A method as recited in claim 31, comprising deriving said successive pluralities of parameter sets by utilizing reconstruction of data sets of said plurality of parameter sets in a lower-dimensional space, while optimally preserving ranking and mutual distances, considered in a least-squares sense.

33. A method as recited in claim 31, comprising utilizing user input as said ranking input.

34. A method as recited in claim 31, comprising using comparisons with a desired standard as said ranking input.

35. A method for interactively optimizing parameters in a parameter set for controlling an image filtering algorithm, comprising:
inputting an original image to said image filtering algorithm;
deriving successive pluralities of parameter sets in a parameter space;
deriving a plurality of filtered images from said original image, corresponding respectively to each parameter set;
ranking said plurality of images in descending order based on a ranking input and designating a first top-ranking image;
starting with a parameter set corresponding to said first top-ranking image, as a point of departure for deriving a next succeeding plurality of parameter sets in said parameter space, in accordance with said ranking, in conjunction with a step size and a step direction derived from said ranking, in accordance with multidimensional scaling (MDS);
deriving a second plurality of filtered images from said original image, corresponding respectively to each parameter set of said succeeding plurality;
ranking said second plurality of images in descending order based on a ranking input and designating a second top-ranking image; and
starting with a parameter set corresponding to said second top-ranking image, proceeding analogously, mutatis mutandis, as follows starting with said first top-ranking image until sufficient iterations are made to determine a best one of said top-ranking images.

36. A method as recited in claim 35, comprising utilizing user input as said ranking input.

37. A method as recited in claim 35, comprising using comparisons with a desired standard as said ranking input.

38. A method as recited in claim 37, comprising deriving said plurality of parameter sets by utilizing MDS.

39. A method as recited in claim 38, comprising deriving said plurality of parameter sets by utilizing reconstruction of data sets of said plurality of parameter sets in a lower-dimensional space, while optimally preserving ranking and mutual distances, considered in a least-squares sense.

40. A method for interactively optimizing parameters in a parameter set for controlling an image filtering algorithm, comprising
deriving a first plurality of parameter sets in a parameter space from a given parameter set for controlling said image filtering algorithm;
inputting an initial image for filtering by said image filtering algorithm for deriving a first plurality of filtered images from said initial image, each corresponding to a respective parameter set of said first plurality of parameter sets;
ranking images of said first plurality of filtered images in descending order of optimality, whereof the topmost image is selected as a first optimal image; and
including in a first iteration:
deriving a second plurality of parameter sets from said first plurality of parameter sets beginning with the parameter set corresponding to said first optimal image as a first starting parameter set in a parameter space, wherein other parameter sets of said second plurality are placed in said parameter space, using information from said ranking images of said first plurality of filtered images, said ranking being weighted such that placement of parameter sets of said second plurality in accordance with multi-dimensional scaling so as to increase a likelihood of said other parameter sets of said second plurality including a parameter representing an optimal image in a next iteration of ranking and selection;
deriving a second plurality of filtered images from said second plurality of parameter sets, each corresponding to a respective parameter set of said second plurality of parameter sets, and
ranking images of said second plurality of filtered images in descending order of optimality, whereof the topmost image is selected as a second optimal image.

41. A method in accordance with claim 40, including in a second iteration:
deriving a third plurality of parameter sets from said second plurality of parameter sets beginning with the parameter set corresponding to said second optimal image as a first starting parameter set in said parameter space, and continuing in an analogous manner to selection of said second optimal image to select a third optimal image.

42. A method in accordance with claim 41, wherein a fourth, and optionally, further iterations are performed in accordance with the steps, mutatis mutandis, performed in the foregoing iteration.

43. A method in accordance with claim 42, wherein said parameter space is a multi-dimensional space.

44. A method in accordance with claim 40, wherein said parameter space is a multi-dimensional space.

45. A method in accordance with claim 43, wherein said step of deriving a second plurality of parameter sets comprises utilizing a multi-dimensional scaling algorithm designed to find the optimal search direction in the parameter space, which best preserves relative ranking between said parameter sets.

46. A method in accordance with claim 41, wherein said step of deriving a second plurality of parameter sets comprises computing from said ranking, a center point, a direction for placement of parameter sets and a step size for proceeding in said direction, computed from said ranking.

47. A method in accordance with claim 41, wherein said step of computing from said ranking, a center point, a direction for placement of parameter sets and a step size for proceeding in said direction is performed in each iteration.

48. A method in accordance with claim 47, wherein said step of computing a direction comprises a computing a direction for placement of said parameter sets such that ranking of parameter sets onto the direction vector is preserved, and mutual distances are preserved in an optimal manner.

49. A method in accordance with claim 48, wherein said parameter space is a multi-dimensional space.

50. A method in accordance with claim 49, comprising:
computing said step size, defined as s;
computing said center, defined as C; and
computing said direction \vec{d}, all computations using feedback from said rankings of images of said filtered images.

51. A method in accordance with claim 50, wherein said center point is always set to point with the best rating, whereby said point with the best rating is thus always shown, permitting comparison between different iterations.

52. A method in accordance with claim 51, comprising:
updating said step size in accordance with the following:
if said center point corresponds to an optimal ranking, then dividing said step size by 2, or
if a different point yields the best rating and the best point in the previous iteration was not the center point, multiplying said step size by 1.25 so as to tend to recover from any excessive amount of shrinking in a previous step, or
otherwise, said step size remains unchanged.

53. A method in accordance with claim 52, wherein said computing said direction \vec{d}, in accordance with multidimensional scaling (MDS), is performed as follows:
points in said parameter space be are given as P⁽ⁱ⁾ with coordinates Pⱼ⁽ⁱ⁾ and ratings r⁽ⁱ⁾, with 0≦i<p and 0≦j<n;
differences between the ratings of the image are interpreted as distances between the respective points in said parameter space;
computing a p×p distance matrix D, being a Euclidian Distance, as follows:
Dₖₗ=(r^{(k)}−r^{(l)})²;
computing an auxiliary matrix M with the elements
$${M}_{ab} = - \frac{1}{2} ( {D}_{ab} - \frac{1}{p} {\sum }_{a} {D}_{ab} + \frac{1}{{p}^{2}} {\sum }_{a , b} {D}_{ab} - \frac{1}{p} {\sum }_{b} {D}_{ab} ) ;$$
making a singular value decomposition of M, yielding the eigenvalues λ⁽ⁱ⁾ and the corresponding eigenvectors \vec{e⁽ⁱ⁾};
selecting, in a given setting, only the dimension with the largest eigenvalue and a new direction based on multidimensional scaling is
\vec{d}=\vec{e⁽¹⁾}
where \vec{d} is a unit vector (i.e. |\vec{d}|=1); and
setting a minimum criterion to ensures a non-zero step size in every direction, absent user input setting a step size.

54. A method in accordance with claim 53, wherein;
said number of points, p is taken as not more than six (6) and said number of dimensions, n, is taken as no more than five (5).

55. A method in accordance with claim 54, wherein placement of said points hyper-sphere is as follows:
computing six parameter sets for a next iteration, given a step size s, a center C and a direction \vec{d};
as a first step, said computing is performed is done in an isotropic space, wherein a length unit is the same for all dimensions;
said points are set on a sphere with center Cₛ=(0,0,0,0,0) and radius 1, said placement depending only on \vec{d} and the previous direction;
indexing all points in said isotropic space with ^{iso}:
the first point is the center of the sphere: ^{iso}P⁽⁰⁾=(0;0;0;0;0),
the second point is given by the direction \vec{d}:
^{iso}P⁽¹⁾=^{iso}P⁽⁰⁾+\vec{d}=(d₁;d₂;d₃; d₄;d₅), and
the third point is given by a combination of the last direction and the current one:
$${}^{iso} {P}^{( 2 )} {=}^{iso} {P}^{( 0 )} + \vec{k} , with \vec{k} = \frac{\frac{\vec{d}}{4} + \vec{{d}_{prev}}}{\vert \frac{\vec{d}}{4} + \vec{{d}_{prev}} \vert} ;$$
for the rest of said points, randomly selecting three unit vectors \vec{r₁}, \vec{r₂}, \vec{r₃}, observing a minimal angle of 72°, corresponding to a division of 360° by 5 or, in the alternative, a corresponding division by another number of points, between every pair of them as well as between any of them and \vec{d} and \vec{k}, which conditions are formulated as follows:

|\vec{r₁}|=|\vec{r₂}|=|\vec{r₃}|=1
\vec{rᵢ}·\vec{k}≦cos (72°), i=1, 2, 3
\vec{rᵢ}·\vec{d}≦cos (72°), i=1, 2, 3
\vec{rᵢ}·\vec{rⱼ}≦cos (72°), i, j=1, 2, 3 and i≠j,
said minimal angles ensuring a sufficient difference of said parameter points and the corresponding images; and
defining the remaining three points: ^{iso}P⁽³⁾=^{iso}P⁽⁰⁾+\vec{r₁}, ^{iso}P⁽⁴⁾=^{iso}P⁽⁰⁾+\vec{r₂} and ^{iso}P⁽⁵⁾=^{iso}P⁽⁰⁾+\vec{r₃} by these vectors.

56. A method in accordance with claim 55, wherein:
generating the points in said isotropic space in the case of decreased dimensionality is performed alternatively as follows:
in the case where a user has set the direction in two or more directions to 0, the first point, ^{iso}P⁽⁰⁾, is set to the center: ^{iso}P⁽⁰⁾=(0;0;0;0;0);
placing the other points, depending on the number of dimensions with non-zero step size, as follows:
where no dimension has a non-zero step size: f, all parameters have zero step size, nothing further is done, as the direction vector is identical to the zero-vector and all points are set to the center: ^{iso}P⁽ⁱ⁾=^{iso}P⁽⁰⁾, i=1 . . . p−1;
in the case of one dimension with non-zero step size: if one parameter has non-zero step size, the five points, or another number where the number of points selected is different, in are computed in an adaptation of Brent's Golden Section Search.

57. A method in accordance with claim 56, wherein:
new points in accordance with said adaptation Brent's Golden Section Search are the following:
^{iso}P⁽¹⁾=^{iso}P⁽⁰⁾+φ·\vec{d}
^{iso}P⁽²⁾=^{iso}P⁽⁰⁾−φ·\vec{d}
^{iso}P⁽³⁾=^{iso}P⁽⁰⁾+\vec{d}
^{iso}P⁽⁴⁾=^{iso}P⁽⁰⁾−\vec{d}
^{iso}P⁽⁵⁾=^{iso}P⁽⁰⁾+(1+φ)·\vec{d}
wherein φ denotes the golden section:
$$φ = \frac{\sqrt{5} - 1}{2} \approx 0.618034 .$$

58. A method in accordance with claim 57, wherein:
in the case of two dimensions with non-zero step size: in the case of two varying parameters, wherein a circle is defined by its center and the direction, computing said first point ^{iso}P⁽¹⁾ on said circle as ^{iso}P⁽¹⁾=^{iso}P⁽⁰⁾−\vec{d}; and
the other four being rotations of ^{iso}P⁽¹⁾ of 72° around said center.

59. A method in accordance with claim 58, wherein:
in the case of three dimensions with non-zero step size: if three parameters have non-zero variation, utilizing an equilateral tetrahedron wherein said first point ^{iso}P⁽¹⁾=^{iso}P⁽⁰⁾−\vec{d} being the apex; the other four points lying on a plane corresponding to the ground plane of a tetrahedron, whereof the middle point is herein called M, is M=C+⅓·\vec{d}, and from said middle point M of said ground plane, four vectors orthogonal to \vec{d} lead to the remaining points:
selecting a first vector to P₂ such that the two components with the biggest step sizes are parallel to the direction of the last step;
determining said vector by the following the length condition (\vec{^{iso}P^{(0) iso}P⁽²⁾} has the same length as \vec{d}) and the condition of the perpendicularity between \vec{M^{iso}P⁽²⁾} and \vec{d}, and thus ^{iso}P⁽²⁾. ^{iso}P⁽⁴⁾ is ^{iso}P⁽²⁾ reflected on M;
for the two remaining points, choosing the vectors to be orthogonal to the previously generated vectors, that is, \vec{M^{iso}P⁽³⁾} is rectangular to \vec{M^{iso}P⁽²⁾}, and, wherein, subject to the two other conditions (\vec{M^{iso}P⁽³⁾} rectangular to \vec{d}, \vec{^{iso}P^{(0) iso}P⁽³⁾} has the same length as \vec{d}) determine \vec{M^{iso}P⁽³⁾} and ^{iso}P⁽³⁾. ^{iso}P⁽⁵⁾ is thus the reflection of ^{iso}P⁽³⁾ on M.

60. A method in accordance with claim 59, including:
mapping said points in an isotropic parameter space into an anisotropic parameter space by:
deforming said hyper-sphere into a five-dimensional ellipsoid, taking into account said center C;
utilizing said step size s to determine the size of said sphere; and
initial parameter directions determine the anisotropy of said anisotropic parameter space.

61. A method in accordance with claim 60, wherein said mapping said points in an isotropic parameter space into an anisotropic parameter comprises:
mapping in accordance with the following formula:
Pⱼ⁽ⁱ⁾=C+s·(\vec{dᵢₙᵢₜ})ⱼ·^{iso}Pⱼ⁽ⁱ⁾
wherein (\vec{dᵢₙᵢₜ})ⱼ denotes the j-th component of said initial direction.

62. A method in accordance with claim 60, including performing a permutation of the point numbering.

63. A method for interactively optimizing parameters for controlling an image filtering algorithm, comprising:
inputting an image to said image filtering algorithm;
deriving a plurality of parameter sets from a given parameter set in accordance with multi-dimensional scaling (MDS);
deriving a plurality of filtered images from said image filtering algorithm under control of said plurality of parameter sets, each filtered image being associated with a respective parameter set of said plurality of parameter sets;
selecting an optimal filtered image from said plurality of filtered images; and
ranking the remainder of the filtered images of said plurality in descending order of optimality.

64. A method as recited in claim 63, comprising:
deriving a second plurality of parameter sets from an optimal parameter set associated with said optimal filtered image;
deriving a second plurality of filtered images from said image filtering algorithm under control of said second plurality of parameter sets, each filtered image of said second plurality being associated with a respective parameter set of said second plurality of parameter sets; and
selecting a second optimal filtered image from said second plurality of filtered images and ranking the remainder of the filtered images of said second plurality in descending order of optimality.

65. A method as recited in claim 64, wherein said step of deriving a second plurality of parameter sets comprises including said optimal parameter set in said second plurality of parameter sets.

66. A method as recited in claim 65, wherein said step of deriving a second plurality of filtered images comprises including said optimal filtered image in said second plurality of filtered images.

67. A method as recited in claim 65, comprising:
iteratively performing the following steps, with m=2, m=3, m=4, and so on, until an m^{th} iteration includes an optimal filtered image meeting a required criterion:
deriving an m^{th} plurality of parameter sets from a parameter set associated with the (m−1)^{th} optimal filtered image;
deriving an m^{th} plurality of filtered images from said image filter under control of said m^{th} plurality of parameter sets, each filtered image of said m^{th} plurality being associated with a respective parameter set of said m^{th} plurality of parameter sets; and
selecting said m^{th} optimal filtered image from said m^{th} plurality of filtered images and ranking the remainder of the filtered images of said m^{th} plurality according to distance from said m^{th} optimal filtered image.

68. A method as recited in claim 67, wherein said step of deriving an m^{th} plurality of parameter sets comprises including said parameter set associated with the (m−1)^{th} optimal filtered image.

69. A method as recited in claim 68, wherein deriving a plurality of parameter sets from a given parameter set comprises:
designating by p the number of parameter sets in a plurality of parameter sets;
designating by n the number of dimensions in each parameter;
representing in a multi-dimensional parameter space said p parameter sets;
utilizing information from a step of selecting an optimal filtered image from a plurality of filtered images and ranking the remainder of the filtered images of said plurality according to variation from said optimal image, then
determining a search step size s;
determining a center C for a search; and
determining a search direction \vec{d}.
updating step size s in accordance with the following criteria:
if said center C is associated with an optimal image, then updating step size s by dividing step size s by a first given number,
if a different point from C is associated with said optimal image and said optimal image in the previous iteration was not associated with said center point, step size s is multiplied by a second given number,
otherwise, step size s stays unchanged;
setting center point C to a point associated with an optimal rating; and
determining a search direction \vec{d}, as follows:
wherein said step of representing in a multi-dimensional parameter space said p parameter sets comprises representing in a multi-dimensional parameter space said p parameter sets as:
P⁽ⁱ⁾ with coordinates Pⱼ⁽ⁱ⁾ and ratings r⁽ⁱ⁾, with 0≦i<p and 0≦j<n,
computing a p×p Euclidian Distance matrix D as Dₖₗ=(r^{(k)}−r^{(l)})²,
calculating an auxiliary matrix M with elements
$${M}_{ab} = - \frac{1}{2} ( {D}_{ab} - \frac{1}{p} {\sum }_{a} {D}_{ab} + \frac{1}{{p}^{2}} {\sum }_{a , b} {D}_{ab} - \frac{1}{p} {\sum }_{b} {D}_{ab} ) ,$$
performing a singular value decomposition of M to yield eigenvalues λ⁽ⁱ⁾ and the corresponding eigenvectors \vec{e⁽ⁱ⁾},
selecting that dimension with the largest eigenvalue,
determining a new direction based on multidimensional scaling as \vec{d}=\vec{e⁽¹⁾} where \vec{d} is a unit vector (i.e. |\vec{d}|=1), and
establishing a minimum criterion to ensure a non-zero step size in every direction, absent a contrary user input.

70 A method as recited in claim 69 including:
designating by p the number of parameter sets in a plurality of parameter sets;
designating by n the number of dimensions in each parameter;
representing in a multi-dimensional parameter space said p parameter sets as P⁽ⁱ⁾ with coordinates Pⱼ⁽ⁱ⁾ and ratings r⁽ⁱ⁾, with 0≦i<p and 0≦j<n;
computing a p×p Euclidian Distance matrix D as Dₖₗ=(r^{(k)}−r^{(l)})²;
calculating an auxiliary matrix M with elements
$${M}_{ab} = - \frac{1}{2} ( {D}_{ab} - \frac{1}{p} {\sum }_{a} {D}_{ab} + \frac{1}{{p}^{2}} {\sum }_{a , b} {D}_{ab} - \frac{1}{p} {\sum }_{b} {D}_{ab} ) ;$$
performing a singular value decomposition of M to yield eigenvalues λ⁽ⁱ⁾ and the corresponding eigenvectors \vec{e⁽ⁱ⁾};
selecting that dimension with the largest eigenvalue;
determining a new direction based on multidimensional scaling as \vec{d}=\vec{e⁽¹⁾} where \vec{d} is a unit vector (i.e. |\vec{d}|=1);
establishing a minimum criterion to ensure a non-zero step size in every direction, absent a contrary user input; and
deriving an m^{th} plurality of parameter sets from a parameter set associated with the (n−1)^{th} optimal filtered image.

71. A method for interactively optimizing parameters in a parameter set for controlling an image filtering algorithm, said method comprising:
(a) generating a plurality of parameter sets by varying parameters in a parameter set in accordance with multi-dimensional scaling (MDS);
(b) generating a plurality of filtered images corresponding respectively to parameter sets of said plurality of parameter sets;
(c) selecting an optimal image from said plurality of filtered images, said optimal image corresponding to an optimal parameter set;
(d) ending with said optimal image if a given criterion is met, and if not, then going to step (e);
(e) deriving a further plurality of parameter sets by varying parameters of said optimal parameter set;
(f) generating a further plurality of filtered images corresponding respectively to parameter sets of said further plurality of parameter sets;
(g) selecting a further optimal image from said further plurality of filtered images, said further optimal image corresponding to a further optimal parameter set; and
(h) ending with said further optimal image if said criterion is met; and, if not, then
(i) repeatedly performing, mutatis mutandis, the steps (e), (f), (g), and (h), with a yet further plurality of parameter sets in place of said further plurality of parameter sets, a yet further plurality of filtered images in place of said plurality of filtered images, and a yet further optimal image corresponding to a yet further optimal parameter set, until ending with a last further optimal image when said criterion is met.

72. A method as recited in claim 71, wherein step (c) comprises including said optimal parameter set in said second plurality of parameter sets.

73. A method as recited in claim 71, including applying a qualitative image criterion.

74. A method as recited in claim 71, including applying a comparative criterion by comparing with a reference model image.

75. A method as recited in claim 71, including applying said comparative criterion by comparing respective parameter sets of an optimal image and of a reference model image.

76. A method for interactively optimizing parameters for an image filter, comprising:
applying a first parameter set to an image filter;
inputting an image to said image filter;
deriving a first filtered image from said image filter, corresponding to said first parameter set;
modifying parameters of said first parameter set in accordance with multi-dimensional scaling (MDS) for providing a first plurality of modified parameter sets to said image filter;
deriving a first plurality of filtered images from said image filter corresponding to respective modified parameter sets of said first plurality;
selecting a first optimal image out of said first filtered image and said first plurality of filtered images, said first optimal image corresponding to a respective parameter set, hereinafter referred to as a first optimal parameter set;
modifying parameters of said first optimal parameter set for providing a second plurality of modified parameter sets to said image filter;
deriving a second plurality of filtered images from said image filter corresponding to respective modified parameter sets of said second plurality; and
selecting a second optimal image out of said second plurality of filtered images, said optimal image corresponding to a respective parameter set, hereinafter referred to as a second optimal parameter set.

77. A method for interactively optimizing parameters for controlling an image filter, comprising:
deriving parameters from a first parameter set in accordance with multi-dimensional scaling (MDS) for providing a first plurality of parameter sets to said image filter;
deriving a first plurality of filtered images from said image filter corresponding to respective parameter sets of said first plurality;
selecting a first optimal image out of said filtered images, said first optimal image corresponding to a respective parameter set, hereinafter referred to as a first optimal parameter set;
deriving parameters from said first optimal parameter set for providing a second plurality of parameter sets to said image filter; and
deriving a second plurality of filtered images from said image filter corresponding to respective parameter sets of said second plurality.

78. A method in accordance with claim 77, wherein said method comprises:
applying a plurality of parameter sets successively to said image filter for successively deriving a plurality of filtered images each corresponding respectively a parameter set.

79. A method in accordance with claim 77, wherein said method comprises:
said step of deriving parameters from a first parameter set for providing a first plurality of parameter sets includes;

80. A method for interactively optimizing parameters for controlling an image filter, comprising:
providing a first plurality of parameter sets to said image filter;
deriving a first plurality of filtered images from said image filter each corresponding to a respective parameter set of said first plurality of parameter sets;
selecting a first optimal image out of said first plurality of filtered images, said first optimal image corresponding to a respective parameter set, hereinafter referred to as a first optimal parameter set;
providing a second plurality of parameter sets to said image filter by deriving parameters from said first optimal parameter set by using multi-dimensional scaling (MDS), said second plurality of parameter sets in including said optimal parameter set; and
deriving a second plurality of filtered images from said image filter corresponding to respective parameter sets of said second plurality.

81. A method in accordance with claim 80, wherein said step of providing a first plurality of parameter sets comprises deriving said plurality of parameter sets from an initial parameter set.

82 A method in accordance with claim 81 including:
providing said first plurality of parameter sets to include said initial parameter set;

83 A method in accordance with claim 80 including:
selecting a second optimal image out of said second plurality of filtered images, said second optimal image corresponding to a respective parameter set, hereinafter referred to as a second optimal parameter set;
providing a third plurality of parameter sets to said image filter by deriving parameters from said second optimal parameter set in accordance with multi-dimensional scaling (MDS); and
deriving a third plurality of filtered images from said image filter corresponding to respective parameter sets of said third plurality.
selecting a third optimal image out of said third plurality of filtered images, said third optimal image corresponding to a respective parameter set, hereinafter referred to as a third optimal parameter set.

84. A method in accordance with-claim 83 including:
providing said second plurality of parameter sets to include said first optimal parameter set.

85 A method in accordance with claim 80, wherein said method comprises:
applying a plurality of parameter sets successively to said image filter for successively deriving a plurality of filtered images each corresponding respectively a parameter set.

86. A method in accordance with claim 85 including repetitively:
selecting a further optimal image out of said second plurality of filtered images, said further optimal image corresponding to a respective parameter set, hereinafter referred to as a further optimal parameter set;
providing a still further plurality of parameter sets in accordance with multi-dimensional scaling (MDS) to said image filter by deriving parameters from said further optimal parameter set;
deriving a still further plurality of filtered images from said image filter corresponding to respective parameter sets of said still further plurality;
selecting a still further optimal image out of said still further plurality of filtered images, said still further optimal image corresponding to a respective parameter set, hereinafter referred to as a still further optimal parameter set.

87. A method in accordance with claim 86, comprising:
repetitively performing the steps of claim D6 by providing successive parameter sets to said image filter, wherein said parameter sets are derived from the foregoing optimal parameter set for providing successive pluralities of filtered images, whereof a respective optimal image is selected corresponding to a respective optimal parameter set; and
continuing said repetitively performing until at least one of:
(a) a satisfactory degree of optimization has been reached, and
(b) a defined criterion has been reached.

88 A method in accordance with claim 87 comprising:
providing a further plurality of parameter sets to said image filter by deriving parameters from said the previous optimal parameter set; and
deriving a further plurality of filtered images from said image filter corresponding to respective parameter sets of said further plurality of parameter sets.

89. A method for interactively optimizing parameters for controlling an image filtering algorithm, comprising:
inputting an image to said image filtering algorithm;
designating a number of parameter sets in a plurality of parameter sets;
designating a number of dimensions in each parameter;
representing in a multi-dimensional parameter space said number of parameter sets;
deriving a plurality of parameter sets from a given parameter set in accordance with multi-dimensional scaling (MDS);
deriving a plurality of filtered images from said image filtering algorithm under control of said plurality of parameter sets, each filtered image being associated with a respective parameter set of said plurality of parameter sets;
selecting an optimal filtered image from said plurality of filtered images, said optimal filtered image being associated with a parameter set hereinafter referred to as an optimal parameter set;
ranking the remainder of the filtered images of said plurality in descending order of optimality;
utilizing information from said step of selecting an optimal filtered image from a plurality of filtered images and ranking the remainder of the filtered images of said plurality according to variation from said optimal image, to
determine a search step size,
determine a center for a search, and
determine a search direction;
deriving a second plurality of parameter sets from said optimal parameter set, by using said search step size, said center for a search, and said search direction;
deriving a second plurality of filtered images from said image filtering algorithm under control of said second plurality of parameter sets, each filtered image of said second plurality being associated with a respective parameter set of said second plurality of parameter sets;
selecting a second optimal filtered image from said second plurality of filtered images and ranking the remainder of the filtered images of said second plurality in descending order of optimality, said second optimal filtered image being associated with a parameter set hereinafter referred to as an optimal parameter set;
utilizing information from said step of selecting a second optimal filtered image from said plurality of filtered images and and ranking the remainder of said second plurality of filtered images according to variation from said optimal image, to
determine a second search step size,
determine a second center for a search, and
determine a second search direction; and
deriving a third plurality of parameter sets from said second optimal parameter set, by using said second search step size, said second center for a search, and said second search direction.

90. A method as recited in claim 89, wherein said step of deriving a second plurality of parameter sets comprises including said optimal parameter set in said second plurality of parameter sets.

91. A method as recited in claim 90, wherein said step of deriving a third plurality of parameter sets comprises including said second optimal parameter set in said third plurality of parameter sets.

92. A method as recited in claim 89, comprising:
iteratively performing the following steps, with m=4, m=5, m=6, and so on, until an m^{th} iteration includes an optimal filtered image meeting a required criterion:
deriving an m^{th} plurality of parameter sets from a parameter set associated with the (m−1)^{th} optimal filtered image;
deriving an m^{th} plurality of filtered images from said image filter under control of said m^{th} plurality of parameter sets, each filtered image of said m^{th} plurality being associated with a respective parameter set of said m^{th} plurality of parameter sets; and
selecting said m^{th} optimal filtered image from said m^{th} plurality of filtered images and ranking the remainder of the filtered images of said m^{th} plurality according to distance from said m^{th} optimal filtered image.

93. A method as recited in claim 92 wherein said step of determining a search direction \vec{d} comprises updating step size s in accordance with the following criteria:
if said center C is associated with an optimal image, then updating step size s by dividing step size s by a first given number,
if a different point from C is associated with said optimal image and said optimal image in the previous iteration was not associated with said center point, step size s is multiplied by a second given number,
otherwise, step size s stays unchanged;
setting center point C to a point associated with an optimal rating; and
determining a search direction \vec{d}, as follows:
wherein said step of representing in a multi-dimensional parameter space said p parameter sets comprises representing in a multi-dimensional parameter space said p parameter sets as:
P⁽ⁱ⁾ with coordinates Pⱼ⁽ⁱ⁾ and ratings r⁽ⁱ⁾, with 0≦i<p and 0≦j<n;
computing a p×p Euclidian Distance matrix D as Dₖₗ=(r^{(k)}−r^{(l)})²;
calculating an auxiliary matrix M with elements
$${M}_{ab} = - \frac{1}{2} ( {D}_{ab} - \frac{1}{p} {\sum }_{a} {D}_{ab} + \frac{1}{{p}^{2}} {\sum }_{a , b} {D}_{ab} - \frac{1}{p} {\sum }_{b} {D}_{ab} ) ;$$
performing a singular value decomposition of M to yield eigenvalues λ⁽ⁱ⁾ and the corresponding eigenvectors \vec{e⁽ⁱ⁾};
selecting that dimension with the largest eigenvalue;
determining a new direction based on multidimensional scaling as \vec{d}=\vec{e⁽¹⁾} where \vec{d} is a unit vector (i.e. |\vec{d}|=1); and
establishing a minimum criterion to ensure a non-zero step size in every direction, absent a contrary user input.

94. A method for interactively optimizing parameters in a parameter set, comprising:
deriving a plurality of parameter sets in a parameter space, from an initial parameter set;
selecting an optimal parameter set of said plurality;
ranking the remaining parameter sets in descending order from said optimal parameter set;
starting with said optimal parameter set as a center in said parameter space, deriving a step size and a step direction from said ranking, in accordance with multidimensional scaling (MDS);
deriving a further plurality of parameter sets in said parameter space, in accordance with said center, said step size, and said direction while preserving said ranking;
selecting a further optimal parameter set of said further plurality;
ranking the remaining parameter sets of said further plurality in descending order from said optimal parameter set; and
starting from said further optimal parameter set as a center in place of said optimal parameter set, iterating the subsequent steps until a best one of said optimal parameter sets is reached.

95. A method as recited in claim 94, comprising utilizing user input as said ranking input.

96. A method as recited in claim 95, comprising using comparisons with a desired standard as said ranking input.

97. A method as recited in claim 96, comprising optimizing parameters controlling an image filtering algorithm.

98. A method as recited in claim 97, comprising deriving said plurality of parameter sets by utilizing MDS.

99. A method as recited in claim 98, comprising deriving said plurality of parameter sets by utilizing reconstruction of data sets of said plurality of parameter sets in a lower-dimensional space, while optimally preserving ranking and mutual distances, considered in a least-squares sense.

100. A system for interactively optimizing performance of a system comprising: means for interactively adjusting controlling parameters in a parameter set, by deriving successive pluralities of parameter sets in a parameter space, each of whose respective member parameter sets are respectively ranked in order, means for utilizing a ranking input based on respective system performance associated with each parameter set and means for selecting from each of which plurality of parameter sets an optimal parameter set and using said optimal parameter set as a point of departure for deriving the next following plurality of parameter sets in said parameter space, in accordance with said preceding ranking, in conjunction with a step size and a step direction derived from said ranking, in accordance with multidimensional scaling (MDS).

101. A system for optimizing performance of a system, comprising:
means for interactively adjusting controlling parameters in a parameter set comprising respective member parameter sets, said means comprising:
means for deriving successive pluralities of parameter sets in a parameter space;
means for ranking each of said respective member parameter sets in order, utilizing a ranking input based on respective system performance associated with each parameter set;
means for selecting an optimal parameter set from said plurality of parameter sets; and
means for using said optimal parameter set as a point of departure for deriving a next following plurality of parameter sets in said parameter space, in accordance with the preceding ranking, in conjunction with a step size and a step direction derived from the ranking, in accordance with multidimensional scaling (MDS).

102. A system as recited in claim 101, comprising:
means for deriving said successive pluralities of parameter sets by utilizing reconstruction of data sets of said plurality of parameter sets in a lower-dimensional space, while optimally preserving ranking and mutual distances, considered in a least-squares sense.

103. A system as recited in claim 102, comprising:
means for utilizing user input as said ranking input.

104. A system as recited in claim 103, comprising:
means for using comparisons with a desired standard as said ranking input.

105. A system for optimizing performance of a system, comprising:
means for interactively adjusting controlling parameters in a parameter set comprising respective member parameter sets, said adjusting comprising:
means for deriving a first plurality of parameter sets in a parameter space from a given parameter set for controlling said system;
means for ranking each of said respective parameter sets in order, utilizing a ranking input based on respective system performance associated with each parameter set, wherein a topmost ranked parameter set is selected as a first optimal parameter set; and
means for using said optimal parameter set as a point of departure for deriving a next following plurality of parameter sets in said parameter space, in accordance with the preceding ranking, in conjunction with a step size and a step direction derived from the ranking, in accordance with multidimensional scaling (MDS).

106. A system in accordance with claim 105, including means for:
in a first iteration: deriving a second plurality of parameter sets from said first plurality of parameter sets beginning with the said first optimal parameter set as a first starting parameter set in said parameter space, wherein other parameter sets of said second plurality are placed in said parameter space, using information from said ranking, said ranking being weighted for placement of parameter sets of said second plurality in accordance with multi-dimensional scaling so as to increase a likelihood of said other parameter sets of said second plurality including a parameter representing an optimal parameter in a next iteration of ranking and selection; and
ranking performance with said second plurality of parameter sets in descending order of optimality, whereof the topmost parameter set is selected as a second optimal parameter set.

107. A system in accordance with claim 106, including means for, in a second iteration: deriving a third plurality of parameter sets from said second plurality of parameter sets beginning with said second optimal parameter set as a second starting parameter set in said parameter space, and continuing in an analogous manner to selection of said second optimal parameter set to select a third optimal parameter set.

108. A system in accordance with claim 107, including means for performing a fourth, and optionally, further iterations are performed, mutatis mutandis, in accordance with the foregoing iteration.

109. A system in accordance with claim 106, wherein said parameter space is a multi-dimensional space.

110. A system in accordance with claim 108, wherein said parameter space is a multi-dimensional space.

111. A system in accordance with claim 106, wherein said means for deriving a second plurality of parameter sets comprises means utilizing a multi-dimensional scaling algorithm designed to find an optimal search direction in said parameter space, which best preserves relative ranking between said parameter sets.

112. A system in accordance with claim 111, wherein said means for deriving a second plurality of parameter sets comprises means for computing from said ranking, a center point, a direction for placement of parameter sets and a step size for proceeding in said direction, computed from said ranking.

113. A system in accordance with claim 112, wherein said means for computing from said ranking, a center point, a direction for placement of parameter sets and a step size for proceeding in said direction comprises means for performing said computing in each iteration.

114. A system in accordance with claim 113, wherein said means for computing a direction comprises means for computing a direction for placement of said parameter sets such that ranking of parameter sets onto the direction vector is preserved, and mutual distances are preserved in an optimal manner.

115. A system in accordance with claim 114, wherein said parameter space is a multi-dimensional space.

116. A system in accordance with claim 115, comprising means for:
computing said step size, defined as s;
computing said center, defined as C; and
computing said direction \vec{d}, all computations using feedback from said rankings.

117. A computer program product comprising a computer useable medium having computer program logic recorded thereon for program code for optimizing a system, comprising:
interactively adjusting controlling parameters in a parameter set comprising respective member parameter sets, said adjustment comprising:
deriving successive pluralities of parameter sets in a parameter space;
ranking each of said respective member parameter sets in order, utilizing a ranking input based on respective system performance associated with each parameter set;
selecting an optimal parameter set from said plurality of parameter sets; and
using said optimal parameter set as a point of departure for deriving a next following plurality of parameter sets in said parameter space, in accordance with the preceding ranking, in conjunction with a step size and a step direction derived from the ranking, in accordance with multidimensional scaling (MDS).
